(19) United States
(12) Patent Application Publication
(10) Pub. No.: US 2025/0256773 A1
(43) Pub. Date: Aug. 14, 2025

(54) FRONT DIFFERENTIAL HYDRAULIC DRIVE SYSTEM FOR SELF-PROPELLED WINDROWER IMPLEMENT

(71) Applicant: DEERE & COMPANY, MOLINE, IL (US)

(72) Inventors: Nicholas J. Depenbusch, OTTUMWA, IA (US); JASON J. WANNER, CEDAR FALLS, IA (US); Conrado W. Scherer, Ottumwa, IA (US); Sameer Gorivale, PUNE (IN); Mahi Agrawal, PUNE (IN)

(21) Appl. No.: 18/439,810

(22) Filed: Feb. 13, 2024

(51) Int. Cl. B62D 11/00; A01B 69/00

(52) U.S. Cl. CPC B62D 11/005; A01B 69/007

(57) ABSTRACT

A self-propelled windrower implement includes a drive pump coupled to and powered by a primary power supply. A drive motor is disposed in fluid communication with the drive pump and is operable to convert a fluid flow from the drive pump into a rotational output having a torque and a rotational speed. A drive wheel is drivenly coupled to the drive motor for rotation about a drive axis in response to the rotational output of the drive motor. The drive motor is a variable displacement hydraulic motor that is controllable to adjust a motor displacement to vary at least one of the torque and the rotational speed of the rotational output for the defined flow rate and the defined pressure of the fluid flow from the drive pump.

### TECHNICAL FIELD

The disclosure generally relates to a self-propelled windrower implement having a front differential hydraulic drive system.

### BACKGROUND

Some work vehicles, including but not limited to agricultural vehicles such as combines and/or self-propelled windrower implements, may include a front differential drive system which includes a forward set of drive wheels mounted in a fixed, forward facing orientation to a chassis. In other words, the front wheels are not free to turn left or right about a respective vertical axis to turn the vehicle. In such a configuration, the vehicle may be propelled forward by driving and/or rotating the forward set of drive wheels at the same rotational speed. The vehicle may be steered by driving and/or rotating the front set of drive wheels at different rotational speeds relative to each other.

In one implementation, the front drive wheels may be driven and/or rotated by a hydraulic drive system, which may include a hydraulic pump that supplies fluid to a hydraulic motor. The hydraulic pump circulates a fluid at a fluid flow rate and pressure to the hydraulic motor. The motor converts the hydraulic energy from the circulating fluid into rotational mechanical energy to rotate the front drive wheels.

### SUMMARY

A self-propelled windrower implement is provided. The self-propelled windrower implement includes a front differential hydraulic drive system. The front differential hydraulic drive system includes a primary power supply and a drive pump coupled to and powered by the primary power supply. The drive pump is operable to circulate a fluid flow at a defined flow rate and a defined pressure. The front differential hydraulic drive system further includes a drive motor disposed in fluid communication with the drive pump. The drive motor is operable to convert the fluid flow from the drive pump into a rotational output having a torque and a rotational speed. A drive wheel is drivenly coupled to the drive motor for rotation about a drive axis in response to the rotational output of the drive motor. The drive motor is a variable displacement hydraulic motor that is controllable to adjust a motor displacement to vary at least one of the torque and the rotational speed of the rotational output for the defined flow rate and the defined pressure of the fluid flow from the drive pump.

In one aspect of the disclosure, the motor displacement of the variable displacement hydraulic motor is adjustable to an infinite number of positions between a maximum displacement and a minimum displacement. The maximum displacement generates a maximum torque and a minimum rotational speed of the rotational output of the drive motor. The minimum displacement generates a minimum torque and a maximum torsional speed of the rotational output of the drive motor. The motor displacement may be controlled to an infinite number of positions between the maximum displacement and the minimum displacement to infinitely vary the torque and rotational speed of the rotational output of the drive motor between the maximum and minimum values of the torque and the maximum and minimum values of the rotational speed.

In one aspect of the disclosure, the drive pump includes one of a fixed displacement pump, a dual speed fixed displacement pump, or a variable displacement pump. The fixed displacement pump is operable to circulate the fluid at a single, fixed flow rate. The flow rate from the fixed displacement pump can not be adjusted or varied. The dual speed fixed displacement pump is operable to circulate the fluid at either a first speed providing a first fixed flow rate, or a second speed providing a second fixed flow rate. The dual speed fixed displacement pump may be controlled between the first speed and the second speed. The variable displacement pump is controllable to vary pump displacement to vary the amount of fluid pumped/circulated per revolution of the drive pump.

In one aspect of the disclosure the front differential hydraulic drive system of the self-propelled windrower includes a fluid circuit. The fluid circuit connects a tank, the drive pump, and the drive motor in fluid communication. The fluid circuit may include a first portion connecting the tank and the drive pump in fluid communication, whereby the drive pump is operable to draw the fluid from the tank. The fluid circuit may include a second portion connecting the drive pump and the drive motor in fluid communication, whereby the drive pump circulates the fluid to the drive motor. The fluid circuit may include a third portion connecting the drive motor and the tank in fluid communication, whereby the drive motor exhausts the fluid to the tank. Accordingly, it should be appreciated that the first portion, the second portion, and the third portion are arranged in sequence to complete and/or define the fluid flow path of the front differential hydraulic drive system.

In one aspect of the disclosure, the primary power supply may include, but is not limited to, an internal combustion engine operable to rotate a crankshaft. The drive pump is connected to and rotatably driven by the crankshaft. In other implementations, the primary power supply may be configured to include a different power source other than the example implementation of the internal combustion engine.

In one aspect of the disclosure, the self-propelled windrower implement includes a second front differential hydraulic drive system. The second front differential hydraulic drive system may be positioned on an opposing lateral side of the self-propelled windrower implement, such that the first front differential hydraulic drive system is coupled to a front left drive wheel, and the second front differential hydraulic drive system is coupled to a front right drive wheel. The second front differential hydraulic drive system may include a second drive pump coupled to and powered by the primary power supply. The second drive pump is operable to circulate a second fluid flow at the defined flow rate and the defined pressure. A second drive motor is disposed in fluid communication with the second drive pump and operable to convert the second fluid flow from the second drive pump into a second rotational output having a second torque and a second rotational speed. A second drive wheel is drivenly coupled to the second drive motor for rotation about the drive axis in response to the second rotational output of the second drive motor. The second drive motor is a variable displacement hydraulic motor that is controllable to adjust a motor displacement of the second drive motor to vary at least one of the second torque and the second rotational speed of the second rotational output for the defined flow rate and the defined pressure of the second fluid flow from the second drive pump.

In one aspect of the disclosure, the self-propelled windrower implement may further include a controller. The controller may be configured for communicating a variable motor control signal to the drive motor for controlling the motor displacement of the drive motor. The controller may communicate the variable motor control signal in response to one of a steering input command or a speed input command.

In one aspect of the disclosure, the first drive wheel and the second drive wheel may be non-steerable wheels that are operable to rotate about the drive axis, but are otherwise non-rotatable about other axis. In other words, the first drive wheel and the second drive wheel are non-rotatable about generally vertical axis and are incapable of changing their respective angular orientation relative to a chassis of the self-propelled windrower implement.

Accordingly, the variable displacement drive motor is positioned within the fluid circuit immediately adjacent to the drive wheel within the fluid circuit. Having the variable displacement drive motor immediately adjacent to the drive wheel decreases the response time and/or latency that may be caused by changes in the fluid flow rate and/or pressure within the fluid circuit of the front differential hydraulic drive system, thereby improving responsiveness of the front differential hydraulic drive system. The responsiveness to controlled changes in the fluid flow rate and fluid pressure in the front differential hydraulic drive system described herein is increased when compared to systems that utilized a variable hydraulic pump in combination with a fixed displacement hydraulic motor adjacent the drive wheels.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic perspective view of a self-propelled windrower implement.

FIG. 2 is a schematic plan view of the self-propelled windrower implement.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

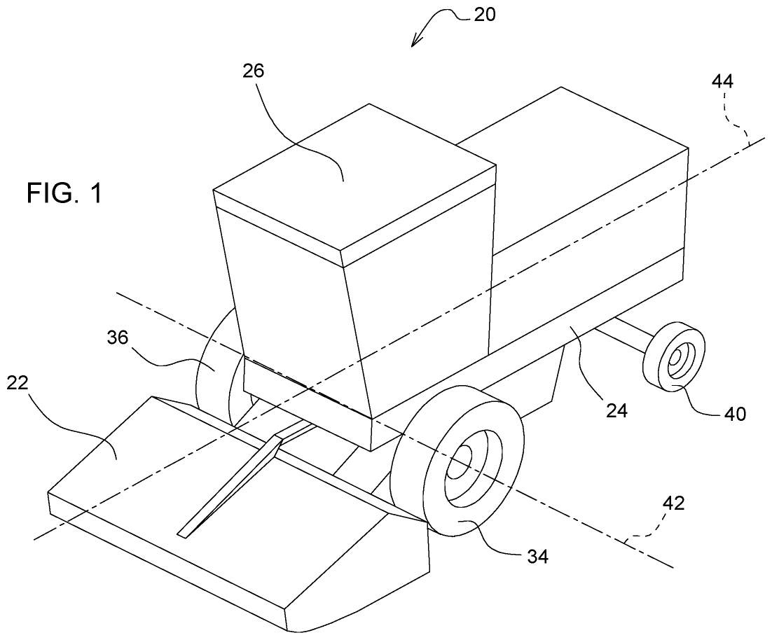

Referring to the Figures, wherein like numerals indicate corresponding parts throughout the several views, an exemplary implementation of a vehicle is generally shown at 20 in FIG. 1. The example implementation of the vehicle 20 is shown as, and may be referred to as, the self-propelled windrower implement 20. The example implementation of the vehicle 20 includes a header 22 configured for cutting and gathering crop material into a windrow. It should be appreciated that the vehicle 20 may be configured differently than the example implementation shown and described herein, such as but not limited to a combine, a lawn mower, or some other moveable platform utilizing a differential hydraulic drive system for both propulsion and steering. The different components and systems of the vehicle 20 may differ from the example implementation of the vehicle 20 shown in the Figures and described herein.

Referring to FIG. 1, the vehicle 20 includes a frame and/or chassis 24, on which may be supported an operator's station 26, from which an operator may control the vehicle 20. The operator's station 26 may include the various controls, displays, input devices, etc., necessary for the operator to control the vehicle 20.

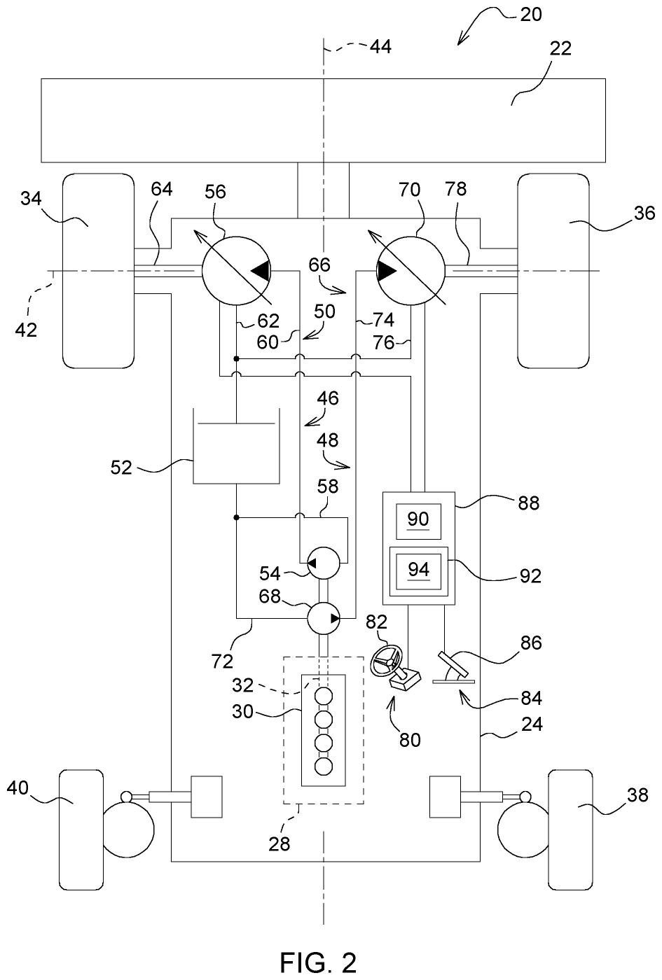

Referring to FIG. 2, the vehicle 20 includes a primary power supply 28 supported by the chassis 24. The primary power supply 28 is operable to supply the power for the various components and systems of the vehicle 20. In one implementation, the primary power supply 28 may include an internal combustion engine 30. As is understood by those skilled in the art, the internal combustion engine 30 burns a fuel, e.g., gasoline, diesel fuel, or propane, which in turn rotates a crankshaft 32 to provide power. Features, components, and operation of the different variations of the internal combustion engine 30 are well known to those skilled in the art, are not pertinent to the teachings of this disclosure, and are therefore not described in greater detail herein. It should be appreciated that the implementation of the primary power supply 28 may differ from the example implementation of the internal combustion engine 30, and may include, for example, and electrical powertrain, a hybrid powertrain, i.e., a combination of the internal combustion engine 30 and an electrical powertrain, or some other power generating system not described herein.

The frame 24 supports at least one drive wheel. In the example implementation shown in the Figures and described herein, the frame 24 supports a front left drive wheel 34 and a front right drive wheel 36. The front left drive wheel 34 may be referred to herein as the first drive wheel 34. The front right drive wheel 36 may be referred to herein as the second drive wheel 36. Additionally, in the example implementation shown in the Figures and described herein, the frame 24 further supports a rear right caster wheel 38, and a rear left caster wheel 40. It should be appreciated that the configuration of wheels and their relative location on the frame 24, i.e., front, rear, left, right may differ from the example implementation described herein. Additionally, the term “wheel”, as used herein, should be interpreted to include other ground engaging devices, such as but not limited to, tracks or other similar devices.

In the example implementation of the vehicle 20, the second drive wheel 36 and the first drive wheel 34 are fixed in a forward-facing orientation and are both rotatable about a drive axis 42. The drive axis 42 extends perpendicular to a central longitudinal axis 44 of the vehicle 20, across a width of the frame 24. The first drive wheel 34 and the second drive wheel 36 do not pivot about respective vertical axes for steering. As such, the first drive wheel 34 and the second drive wheel 36 may be considered and/or referred to as non-steerable wheels. The rear right caster wheel 38 and the rear left caster wheel 40 are rotatably attached to the frame 24, such that the rear right caster wheel 38 and the rear left caster wheel 40 are rotatable about respective vertical axes.

The example implementation of the vehicle 20 shown in the Figures and described herein includes a first differential hydraulic drive system 46 and a second differential hydraulic drive system 48. The first differential hydraulic drive system 46 is configured to drive and/or rotate the first drive wheel 34 about the drive axis 42, and the second differential hydraulic drive system 48 is configured to drive and/or rotate the second drive wheel 36 about the drive axis 42. The first differential hydraulic drive system 46 and the second differential hydraulic drive system 48 may each be controlled to rotate the first drive wheel 34 and the second drive wheel 36 respectively at an identical rotational speed to propel the vehicle 20 in a straight line. The first differential hydraulic drive system 46 and the second differential hydraulic drive system 48 may each be controlled to rotate the first drive wheel 34 and the second drive wheel 36 respectively at different rotational speeds to generate a steering effect on the vehicle 20 and thereby turn the vehicle 20.

The first differential hydraulic drive system 46 includes a first fluid circuit 50 connecting a tank 52, a first drive pump 54, and a first drive motor 56 disposed in fluid communication with each other. The first fluid circuit 50 defines the fluid passageways between and the fluid flow path between the tank 52, first drive pump 54 and the first drive motor 56. As such, it should be appreciated that the first fluid circuit 50 may include, but is not limited to, all connections tubes, hoses, fittings, etc., interconnecting and defining the closed fluid passage between the tank 52, first drive pump 54, and first drive motor 56.

The first fluid circuit 50 may include a first portion 58 connecting the tank 52 and the first drive pump 54 in fluid communication, whereby the first drive pump 54 is operable to draw a fluid from the tank 52. The first drive pump 54 circulates the fluid through the first fluid circuit 50. The first fluid circuit 50 may include a second portion 60 connecting the first drive pump 54 and the first drive motor 56 in fluid communication. The first drive pump 54 circulates the fluid to the first drive motor 56. The first fluid circuit 50 may include a third portion 62 connecting the first drive motor 56 and the tank 52 in fluid communication. The first drive motor 56 exhausts or discharges the fluid received from the first drive pump 54 back to the tank 52, thereby completing the first fluid circuit 50.

The first drive pump 54 is coupled to and powered by the primary power supply 28. In one example implementation, the first drive pump 54 may be connected to and rotatably driven by the crankshaft 32 of the internal combustion engine 30. As such, the internal combustion engine 30 provides the rotational power to rotate the first drive pump 54. It should be appreciated that the first drive pump 54 may be connected to the primary power source in some other manner not described herein that enables the primary power source to power and rotate the first drive pump 54.

The first drive pump 54 is a hydraulic pump that is operable to circulate a fluid flow through the first fluid circuit 50 at a defined flow rate and a defined pressure. The first drive pump 54 is a device that converts mechanical power, e.g., rotation of the crankshaft 32 of the internal combustion engine 30, into hydraulic energy, i.e., fluid pressure and fluid flow. The first drive pump 54 may include for example, but is not limited to, a gear pump, a rotary vane pump, a screw pump, a bent axis pump, an inline axial piston pump, a radial piston pump, etc.

The first drive pump 54 may include one of a fixed displacement pump, a dual speed fixed displacement pump, or a variable displacement pump. As is understood by those skilled in the art, the fixed displacement pump is only operable to circulate the fluid at a single, fixed flow rate. The single flow rate from the fixed displacement pump cannot be adjusted or varied. The dual speed fixed displacement pump is only operable to circulate the fluid at either a first speed providing a first fixed flow rate, or a second speed providing a second fixed flow rate. The dual speed fixed displacement pump may only be controlled between the first speed and the second speed. The variable displacement pump is controllable to vary pump displacement to vary the amount of fluid pumped/circulated per revolution of the drive pump. The variable displacement pump may vary pump displacement to an infinite number of positions between a maximum displacement position and a minimum displacement position.

The first drive motor 56 is disposed in fluid communication with the first drive pump 54 for receiving the fluid flow from the first drive pump 54. The first drive motor 56 is operable to convert the fluid flow from the first drive pump 54 into a first rotational output 64 having a first torque and a first rotational speed. The first drive motor 56 is a mechanical actuator that converts hydraulic energy, i.e., fluid pressure and fluid flow, into torque and angular displacement (rotation). The first drive motor 56 may include for example, but is not limited to, a vane motor, a gear motor, a gerotor motor, an axial plunger motor, a radial piston motor, etc.

The first drive wheel 34 is drivenly coupled to the first drive motor 56 for rotation about the drive axis 42 in response to the first rotational output 64 of the first drive motor 56. The first rotational output 64 of the first drive motor 56 may include, for example, a rotatable shaft output. The first drive wheel 34 may be directly coupled to the first rotational output 64 of the first drive motor 56, e.g., the rotatable saft output, such that the first rotational output 64 directly drives and/or rotates the first drive wheel 34. In other implementations, the first drive wheel 34 may be indirectly coupled to the first rotational output 64 of the first drive motor 56, for example, via a geartrain, a transmission, a shaft, a coupling, etc.

The first drive motor 56 is a variable displacement hydraulic motor that is controllable to adjust a motor displacement to vary at least one of the first torque and the first rotational speed of the first rotational output 64 for the defined flow rate and the defined pressure of the first fluid flow from the first drive pump 54. As used herein, the term “motor displacement” refers to the volume of fluid required to turn a hydraulic motor through one revolution. As understood by those skilled in the art, hydraulic motor displacement may be fixed or variable. A fixed-displacement motor provides constant torque. Controlling the amount of input flow into a fixed displacement motor varies the speed. As such, speed control of a fixed displacement motor requires the adjustment/control of fluid flow to the fixed displacement motor, e.g., from an associated pump. In contrast, the variable displacement hydraulic motor of the first drive motor 56 is controllable to provide variable torque and variable speed for a constant fluid flow from the first drive pump 54. With input flow and pressure constant, varying the motor displacement of the variable displacement hydraulic motor can vary the torque speed ratio to meet load requirements. As such, the variable displacement hydraulic motor of the first drive motor 56, which is positioned immediately adjacent to the first drive wheel 34, may be paired with a fixed displacement pump, and be operable to control the wheel speed of the vehicle 20.

The motor displacement of the variable displacement hydraulic motor of the first drive motor 56 may be adjustable to an infinite number of positions between a maximum displacement and a minimum displacement. As such, the first fluid flow rate and the first fluid pressure output by the first drive pump 54 held constant, the first drive motor 56 may be selectively controlled to vary the first torque and the first rotational speed of the first drive wheel 34 to any desired level between a maximum value and a minimum value of the first drive motor 56. The first drive pump 54 may output and continuously circulate the fluid at a constant fluid flow rate and a constant pressure to the first drive motor 56, with the variable displacement hydraulic motor of the first drive motor 56 able to vary the wheel speed of the first drive wheel 34. Because the first drive motor 56 is disposed at the first drive wheel 34, latency and/or delay associated with changing the wheel speed is reduced when compared to other systems that vary the output of the pump to control wheel speed.

The second differential hydraulic drive system 48 includes a second fluid circuit 66 connecting the tank 52, a second drive pump 68, and a second drive motor 70 disposed in fluid communication with each other. The second fluid circuit 66 defines the fluid passageways between and the fluid flow path between the tank 52, second drive pump 68 and the second drive motor 70. As such, it should be appreciated that the second fluid circuit 66 may include, but is not limited to, all connections tubes, hoses, fittings, etc., interconnecting and defining the closed fluid passage between the tank 52, second drive pump 68, and second drive motor 70.

The second fluid circuit 66 may include a first portion 72 connecting the tank 52 and the second drive pump 68 in fluid communication, whereby the second drive pump 68 is operable to draw the fluid from the tank 52. The second drive pump 68 circulates the fluid through the second fluid circuit 66. The second fluid circuit 66 may include a second portion 74 connecting the second drive pump 68 and the second drive motor 70 in fluid communication. The second drive pump 68 circulates the fluid to the second drive motor 70. The second fluid circuit 66 may include a third portion 76 connecting the second drive motor 70 and the tank 52 in fluid communication. The second drive motor 70 exhausts or discharges the fluid received from the second drive pump 68 back to the tank 52, thereby completing the fluid circuit.

The second drive pump 68 is coupled to and powered by the primary power supply 28. In one example implementation, the second drive pump 68 may be connected to and rotatably driven by the crankshaft 32 of the internal combustion engine 30. As such, the internal combustion engine 30 provides the rotational power to rotate the second drive pump 68. It should be appreciated that the second drive pump 68 may be connected to the primary power source in some other manner not described herein that enables the primary power source to power and rotate the second drive pump 68.

The second drive pump 68 is a hydraulic pump that is operable to circulate a fluid flow through the second fluid circuit 66 at a defined flow rate and a defined pressure. The second drive pump 68 is a device that converts mechanical power, e.g., rotation of the crankshaft 32 of the internal combustion engine 30, into hydraulic energy, i.e., fluid pressure and fluid flow. The second drive pump 68 may include for example, but is not limited to, a gear pump, a rotary vane pump, a screw pump, a bent axis pump, an inline axial piston pump, a radial piston pump, etc.

The second drive pump 68 may include one of a fixed displacement pump, a dual speed fixed displacement pump, or a variable displacement pump. As is understood by those skilled in the art, the fixed displacement pump is only operable to circulate the fluid at a single, fixed flow rate. The single flow rate from the fixed displacement pump cannot be adjusted or varied. The dual speed fixed displacement pump is only operable to circulate the fluid at either a second speed providing a second fixed flow rate, or a second speed providing a second fixed flow rate. The dual speed fixed displacement pump may only be controlled between the second speed and the second speed. The variable displacement pump is controllable to vary pump displacement to vary the amount of fluid pumped/circulated per revolution of the drive pump. The variable displacement pump may vary pump displacement to an infinite number of positions between a maximum displacement position and a minimum displacement position.

The second drive motor 70 is disposed in fluid communication with the second drive pump 68 for receiving the fluid flow from the second drive pump 68. The second drive motor 70 is operable to convert the fluid flow from the second drive pump 68 into a second rotational output 78 having a second torque and a second rotational speed. The second drive motor 70 is a mechanical actuator that converts hydraulic energy, i.e., fluid pressure and fluid flow, into torque and angular displacement (rotation). The second drive motor 70 may include for example, but is not limited to, a vane motor, a gear motor, a gerotor motor, an axial plunger motor, a radial piston motor, etc.

The second drive wheel 36 is drivenly coupled to the second drive motor 70 for rotation about the drive axis 42 in response to the second rotational output 78 of the second drive motor 70. The second rotational output 78 of the second drive motor 70 may include, for example, a rotatable shaft output. The second drive wheel 36 may be directly coupled to the second rotational output 78 of the second drive motor 70, e.g., the rotatable saft output, such that the second rotational output 78 directly drives and/or rotates the second drive wheel 36. In other implementations, the second drive wheel 36 may be indirectly coupled to the second rotational output 78 of the second drive motor 70, for example, via a geartrain, a transmission, a shaft, a coupling, etc.

The second drive motor 70 is a variable displacement hydraulic motor that is controllable to adjust a motor displacement to vary at least one of the second torque and the second rotational speed of the second rotational output 78 for the defined flow rate and the defined pressure of the second fluid flow from the second drive pump 68. The variable displacement hydraulic motor of the second drive motor 70 is controllable to provide variable torque and variable speed for a constant fluid flow from the second drive pump 68. With input flow and pressure constant, varying the motor displacement of the variable displacement hydraulic motor of the second drive motor 70 can vary the torque speed ratio to meet load requirements. As such, the variable displacement hydraulic motor of the second drive motor 70, which is positioned immediately adjacent to the second drive wheel 36, may be paired with a fixed displacement pump, and be operable to control the wheel speed of the vehicle 20.

The motor displacement of the variable displacement hydraulic motor of the second drive motor 70 may be adjustable to an infinite number of positions between a maximum displacement and a minimum displacement. As such, the second fluid flow rate and the second fluid pressure generated by the second drive pump 68 held constant, the second drive motor 70 may be selectively controlled to vary the second torque and the second rotational speed of the second rotational output 78 to any desired level between a maximum value and a minimum value of the second drive motor 70. The second drive pump 68 may output and continuously circulate the fluid at a constant fluid flow rate and a constant pressure to the second drive motor 70, with the variable displacement hydraulic motor of the second drive motor 70 able to vary the wheel speed of the second drive wheel 36. Because the second drive motor 70 is disposed at the second drive wheel 36, latency and/or delay associated with changing the wheel speed is reduced when compared to other systems that vary the output of the pump to control wheel speed.

The vehicle 20 may include a steering control system 80 that is operable to receive a steering input command from an operator and/or autonomous controller. The steering control system 80 may include a steering input device 82. The operator uses the steering input device 82 to enter the steering input command. The steering input command is steering input by the operator commanding a turn of the vehicle 20, either left or right. The steering input device 82 may include, but is not limited to, a steering wheel, steering levers, a joystick, a touch screen, etc. The various possible components, systems, and processes for entering the steering input command are understood by those skilled in the art, are not pertinent to the teachings of this disclosure, and are therefore not described in greater detail herein.

The vehicle 20 may include a speed control system 84 that is operable to receive a speed input command from the operator and/or autonomous controller. The speed control system 84 may include a speed input device 86. The operator uses the speed input device 86 to enter the speed input command. The speed input command is a speed input by the operator commanding a desired speed of the vehicle 20. The speed input device 86 may include, but is not limited to, a pedal, a lever, a touch screen, etc. The various possible components, systems, and processes for entering the speed input command are understood by those skilled in the art, are not pertinent to the teachings of this disclosure, and are therefore not described in greater detail herein.

The vehicle 20 may further include a drive system controller 88 configured for communicating a variable motor control signal to the first drive motor 56 and/or the second drive motor 70 for controlling the motor displacement of the first drive motor 56 and/or the second drive motor 70 respectively in response to one of the steering input command or the speed input command.

The drive system controller 88 may be configured as a mechanical controller operable to generate a mechanical control signal or an electrical controller operable to generate an electrical control signal. In one implementation, the drive system controller 88 may be configured as a computing device operable to generate an electrical, mechanical and/or hydraulic control signal. The drive system controller 88 may alternatively be referred to as a module, a control module, a computer, a controller, etc. The drive system controller 88 is configured to control the operation of at least one of the first differential hydraulic drive system 46 and/or the second differential hydraulic drive system 48 of the vehicle 20. The drive system controller 88 may be configured to control other components and/or systems of the vehicle 20 as well. While the drive system controller 88 is generally described herein as a singular device, it should be appreciated that the drive system controller 88 may include multiple devices linked together to share and/or communicate information therebetween.

The drive system controller 88 includes a processor 90, a memory 92, and all software, hardware, algorithms, connections, sensors, etc., necessary to manage and control the operation of the first differential hydraulic drive system 46 and/or the second differential hydraulic drive system 48. As such, a method may be embodied as a program or algorithm operable on the drive system controller 88. It should be appreciated that the drive system controller 88 may include any device capable of analyzing data from various sensors, comparing data, making decisions, and executing the required tasks.

As used herein, “controller” is intended to be used consistent with how the term is used by a person of skill in the art, and refers to a computing component with processing, memory, and communication capabilities, which is utilized to execute instructions (i.e., stored on the memory 92 or received via the communication capabilities) to control or communicate with one or more other components. In certain embodiments, the drive system controller 88 may be configured to receive input signals in various formats (e.g., hydraulic signals, voltage signals, current signals, CAN messages, optical signals, radio signals), and to output command or communication signals in various formats (e.g., hydraulic signals, voltage signals, current signals, CAN messages, optical signals, radio signals).

The drive system controller 88 may be in communication with other components on the vehicle 20, such as hydraulic components, electrical components, and operator inputs within the operator's station 26. The drive system controller 88 may be connected to these other components wirelessly or by a wiring harness, such that messages, commands, and electrical power may be transmitted between the drive system controller 88 and the other components. Although the drive system controller 88 is referenced in the singular, in alternative implementations the configuration and functionality described herein can be split across multiple devices using techniques known to a person of ordinary skill in the art.

The drive system controller 88 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory 92 may include any non-transitory/tangible medium which participates in providing data or computer-readable instructions. The memory 92 may be non-volatile or volatile. Non-volatile media may include, for example, optical or magnetic disks and other persistent memory. Example volatile media may include dynamic random access memory (DRAM), which may constitute a main memory. Other examples of embodiments for memory 92 include a floppy, flexible disk, or hard disk, magnetic tape or other magnetic medium, a CD-ROM, DVD, and/or any other optical medium, as well as other possible memory devices such as flash memory.

The drive system controller 88 includes the tangible, non-transitory memory 92 on which are recorded computer-executable instructions, including a drive control algorithm 94. The processor 90 of the drive system controller 88 is configured for executing the drive control algorithm 94. The drive control algorithm 94 implements a method of controlling the first differential hydraulic drive system 46 and/or the second differential hydraulic drive system 48 of the vehicle 20.

The drive system controller 88 is in communication with the steering input device 82 to receive the steering input command from the steering input device 82. The drive system controller 88 may generate and communicate the drive control signal for the first differential hydraulic drive system 46 and/or the second differential hydraulic drive system 48 based on the steering input command. The drive control signal is configured for controlling the first drive motor 56 and the second drive motor 70 to achieve a desired wheel speed of the first drive wheel 34 and the second drive wheel 36 respectively to execute the steering input command. For example, if the steering input command includes a command for continued straight line driving, then the drive system controller 88 may configure and communicate the drive control signal to control both the first drive motor 56 and the second drive motor 70 to generate identical values of the first rotational output 64 and the second rotational output 78 respectively to maintain a continued and straight direction of travel. In contrast, if the steering input command includes a command for a turn, then the drive system controller 88 may configure and communicate the drive control signal to control the first drive motor 56 and the second drive motor 70 to generate different values of the first rotational output 64 and the second rotational output 78 respectively to execute a turning maneuver of the vehicle 20.

The drive system controller 88 is in communication with the speed input device 86 to receive the speed input command from the speed input device 86. The drive system controller 88 may generate and communicate the drive control signal for the first differential hydraulic drive system 46 and/or the second differential hydraulic drive system 48 based on the speed input command. The drive control signal is configured for controlling the first drive motor 56 and the second drive motor 70 to achieve a desired wheel speed of the first drive wheel 34 and the second drive wheel 36 respectively to execute the speed input command. For example, if the speed input command includes a command for an increased vehicle 20 speed or a reduced vehicle 20 speed, then the drive system controller 88 may configure and communicate the drive control signal to control both the first drive motor 56 and the second drive motor 70 to generate identical values of the first rotational output 64 and the second rotational output 78 respectively to achieve the desired travel speed of the vehicle 20.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A self-propelled windrower implement comprising:
a primary power supply;
a drive pump coupled to and powered by the primary power supply, wherein the drive pump is operable to circulate a fluid flow at a defined flow rate and a defined pressure;
a drive motor disposed in fluid communication with the drive pump and operable to convert the fluid flow from the drive pump into a rotational output having a torque and a rotational speed;
a drive wheel drivenly coupled to the drive motor for rotation about a drive axis in response to the rotational output of the drive motor; and
wherein the drive motor is a variable displacement hydraulic motor that is controllable to adjust a motor displacement to vary at least one of the torque and the rotational speed of the rotational output for the defined flow rate and the defined pressure of the fluid flow from the drive pump.

2. The self-propelled windrower implement set forth in claim 1, wherein the motor displacement of the variable displacement hydraulic motor is adjustable to an infinite number of positions between a maximum displacement and a minimum displacement.

3. The self-propelled windrower implement set forth in claim 1, wherein the drive pump includes one of a fixed displacement pump, a dual speed fixed displacement pump, or a variable displacement pump.

4. The self-propelled windrower implement set forth in claim 1, further comprising a fluid circuit connecting a tank, the drive pump, and the drive motor in fluid communication.

5. The self-propelled windrower implement set forth in claim 4, wherein the fluid circuit includes a first portion connecting the tank and the drive pump in fluid communication whereby the drive pump is operable to draw a fluid from the tank.

6. The self-propelled windrower implement set forth in claim 5, wherein the fluid circuit includes a second portion connecting the drive pump and the drive motor in fluid communication, whereby the drive pump circulates the fluid to the drive motor.

7. The self-propelled windrower implement set forth in claim 6, wherein the fluid circuit includes a third portion connecting the drive motor and the tank in fluid communication, whereby the drive motor exhausts the fluid to the tank.

8. The self-propelled windrower implement set forth in claim 1, wherein the primary power supply includes an internal combustion engine operable to rotate a crankshaft, with the drive pump connected to and rotatably driven by the crankshaft.

9. The self-propelled windrower implement set forth in claim 1, further comprising:
a second drive pump coupled to and powered by the primary power supply, wherein the second drive pump is operable to circulate a second fluid flow at the defined flow rate and the defined pressure;
a second drive motor disposed in fluid communication with the second drive pump and operable to convert the second fluid flow from the second drive pump into a second rotational output having a second torque and a second rotational speed;
a second drive wheel drivenly coupled to the second drive motor for rotation about the drive axis in response to the second rotational output of the second drive motor; and
wherein the second drive motor is a variable displacement hydraulic motor that is controllable to adjust a motor displacement to vary at least one of the second torque and the second rotational speed of the second rotational output for the defined flow rate and the defined pressure of the second fluid flow from the second drive pump.

10. The self-propelled windrower implement set forth in claim 1, further comprising a controller configured for communicating a variable motor control signal to the drive motor for controlling the motor displacement of the drive motor in response to one of a steering input command or a speed input command.

11. The self-propelled windrower implement set forth in claim 1, wherein the drive wheel is a non-steerable wheel.

12. A self-propelled windrower implement comprising:
a primary power supply;
a first drive pump coupled to and powered by the primary power supply, wherein the first drive pump is operable to circulate a first fluid flow at a defined flow rate and a defined pressure;
a first drive motor disposed in fluid communication with the first drive pump and operable to convert the first fluid flow from the first drive pump into a first rotational output having a first torque and a first rotational speed;
a first drive wheel drivenly coupled to the first drive motor for rotation about a drive axis in response to the first rotational output of the first drive motor;
wherein the first drive motor is a variable displacement hydraulic motor that is controllable to adjust a motor displacement to vary at least one of the first torque and the first rotational speed of the first rotational output for the defined flow rate and the defined pressure of the first fluid flow from the first drive pump;
a second drive pump coupled to and powered by the primary power supply, wherein the second drive pump is operable to circulate a second fluid flow at the defined flow rate and the defined pressure;
a second drive motor disposed in fluid communication with the second drive pump and operable to convert the second fluid flow from the second drive pump into a second rotational output having a second torque and a second rotational speed;
a second drive wheel drivenly coupled to the second drive motor for rotation about the drive axis in response to the second rotational output of the second drive motor; and
wherein the second drive motor is a variable displacement hydraulic motor that is controllable to adjust a motor displacement to vary at least one of the second torque and the second rotational speed of the second rotational output for the defined flow rate and the defined pressure of the second fluid flow from the second drive pump.

13. The self-propelled windrower implement set forth in claim 12, wherein the first drive pump includes one of a fixed displacement pump, a dual speed fixed displacement pump, or a variable displacement pump, and wherein the second drive pump includes one of a fixed displacement pump, a dual speed fixed displacement pump, or a variable displacement pump.

14. The self-propelled windrower implement set forth in claim 12, further comprising a first fluid circuit connecting a tank, the first drive pump, and the first drive motor in fluid communication, and a second fluid circuit connecting the tank, the second drive pump, and second drive motor in fluid communication.

15. The self-propelled windrower implement set forth in claim 12, wherein the primary power supply includes an internal combustion engine operable to rotate a crankshaft, with both the first drive pump and the second drive pump connected to and rotatably driven by the crankshaft.

16. The self-propelled windrower implement set forth in claim 12, further comprising a controller configured for communicating a first variable motor control signal to the first drive motor for controlling the motor displacement of the first drive motor in response to one of a steering input command or a speed input command, and communicating a second variable motor control signal to the second drive motor for controlling the motor displacement of the second drive motor in response to one of the steering input command or the speed input command.

17. A front differential hydraulic drive system comprising:
a primary power supply;
a drive pump coupled to and powered by the primary power supply, wherein the drive pump is operable to circulate a fluid flow at a defined flow rate and a defined pressure;
a drive motor disposed in fluid communication with the drive pump and operable to convert the fluid flow from the drive pump into a rotational output having a torque and a rotational speed;
a non-steerable drive wheel drivenly coupled to the drive motor for rotation about a drive axis in response to the rotational output of the drive motor; and
wherein the drive motor is a variable displacement hydraulic motor that is controllable to adjust a motor displacement to vary at least one of the torque and the rotational speed of the rotational output for the defined flow rate and the defined pressure of the fluid flow from the drive pump.

18. The front differential hydraulic drive system set forth in claim 17, further comprising a controller configured for communicating a variable motor control signal to the drive motor for controlling the motor displacement of the drive motor in response to one of a steering input command or a speed input command.

19. The front differential hydraulic drive system set forth in claim 18, further comprising:
a second drive pump coupled to and powered by the primary power supply, wherein the second drive pump is operable to circulate a second fluid flow at the defined flow rate and the defined pressure;
a second drive motor disposed in fluid communication with the second drive pump and operable to convert the second fluid flow from the second drive pump into a second rotational output having a second torque and a second rotational speed;
a second drive wheel drivenly coupled to the second drive motor for rotation about the drive axis in response to the second rotational output of the second drive motor; and
wherein the second drive motor is a variable displacement hydraulic motor that is controllable to adjust a motor displacement to vary at least one of the second torque and the second rotational speed of the second rotational output for the defined flow rate and the defined pressure of the second fluid flow from the second drive pump.

20. The front differential hydraulic drive system set forth in claim 19, wherein the controller is configured for communicating a variable motor control signal to the second drive motor for controlling the motor displacement of the second drive motor in response to one of the steering input command or the speed input command.
